(19) United States
(12) Patent Application Publication
(10) Pub. No.: US 2018/0222161 A1
(43) Pub. Date: Aug. 9, 2018

(54) PACKAGING TRAY WITH CAPPING LAYER

(71) Applicant: Bemis Company, Inc., Neenah, WI (US)

(72) Inventors: JianCheng Liu, Neenah, WI (US); Tyler J. Theobald, Neenah, WI (US); James W. Clements, Russellville, AR (US); Ross K. Gruetzmacher, Neenah, WI (US); Otacilio T. Berbert, Oshkosh, WI (US); Kevin P. Nelson, Appleton, WI (US)

(21) Appl. No.: 15/749,840

(22) PCT Filed: Aug. 26, 2015
(86) PCT No.: PCT/US15/46860

§ 371 Date: Feb. 2, 2018

(51) Int. Cl. B32B 27/08; B65D 1/34; B65D 25/14; B32B 1/02; B32B 27/30; B32B 27/32; B32B 27/36

(52) U.S. Cl. CPC B32B 27/08; B65D 1/34; B65D 25/14; B32B 1/02; B65D 77/2024; B32B 27/308; B32B 27/32; B32B 27/36; B32B 27/306

(57) ABSTRACT

The present invention is directed to rigid or semi-rigid trays having a bulk layer comprising a crystalline aromatic polyester and a capping layer which is in direct contact with the bulk layer. The capping layer comprises a copolymer having a first structural repeating unit of ethylene and a second structural repeating unit selected from the following: (i) an acrylate-based moiety: fit) at least 12% by weight relative to the total weight of the copolymer of vinyl acetate; and (iii) an anhydride or carboxylic acid. It has been discovered that the bulk layer and the capping layer of the present invention can be readily co-extruded together and have sufficient bond strength to each other despite their chemical dissimilarity. In some preferred embodiments, the capping layer acts as a heat seal layer and is formulated to heat seal to conventional polyolefin-based lidstock.

### BACKGROUND OF THE INVENTION

The present invention relates generally to primary packaging and more particularly, to plastic trays. More specifically, this invention relates to polyester trays which will heat seal to lidding films having a polyolefin-based sealant layer.

Polyesters such as polyethylene terephthalate (PET) are engineering thermoplastics used in a wide variety of end use applications such as fibers, films, automotive parts, food and beverage containers and the like. PET can be processed by a variety of techniques including injection molding, compression molding, extrusion, thermoforming, blow molding, and combinations thereof. Extruded into films or sheets of between 100 and 1000 microns thick, PET may be used as-fabricated or shaped, e.g., by thermoforming, into rigid or semi-rigid packaging articles such as trays for containing food products. For example, extruded PET sheet can be thermoformed to make trays, packages or containers in which refrigerated or frozen foods can be both stored and heated and/or cooked in an oven. Such materials are recyclable where the infrastructure is available and certain applications will also be able to incorporate post-consumer recycled content. Food trays fabricated from crystallized PET (CPET) sheet retain good dimensional stability over the range of temperatures commonly encountered during both microwave and conventional oven cooking. When such packages are produced, the food product is placed in a rigid tray, whereupon a flexible plastic lidding film is heat-sealed to the tray by a perimeter heat seal on the flange of the tray to finish the package. The lidding film or lidstock may form a hermetic heat seal to the tray. It is important that there is sufficient adhesion between the lidstock and tray during the packaging process, package shipment and handling, and under cooking and/or pasteurization/sterilization conditions in order to maintain a hermetic heat seal which protects the product from environmental contamination and spoilage. Those skilled in the art have long-recognized that weak seals are often produced when heat sealing two chemically dissimilar materials directly together. It is typical for the outer surface layer or sealant layer of the lidstock to include a resin material which is chemically similar to the material used for the outer surface layer or capping layer of the tray in order to achieve sufficient adhesion between these packaging components. Often, the sealant layer of the lidstock to be sealed to a PET tray comprises co-polyesters including but not limited to polyethylene terephthalate (PET) copolymers, amorphous polyethylene terephthalate (APET) or blends thereof. However, because the bonds between these materials and PET tend to be very strong, the package is difficult to open without the use of knife or other cutting implement. Furthermore, the temperature range for heat sealing these materials together is relatively narrow and generally they do not readily seal through food contamination in the seal area compared to conventional polyolefin-based heat sealing materials.

### SUMMARY OF THE INVENTION

The present invention is directed to rigid or semi-rigid trays having a bulk layer comprising a crystalline aromatic polyester and a capping layer which is in direct contact with the bulk layer. The capping layer comprises a copolymer having a first structural repeating unit of ethylene and a second structural repeating unit selected from the following: (i) an acrylate-based moiety; (ii) at least 12% by weight relative to the total weight of the copolymer of vinyl acetate; and (iii) an anhydride or carboxylic acid. In various preferred embodiments, the capping layer is a film forming thermoplastic comprising at least 50% by weight, at least 60% by weight, at least 70% by weight, at least 75% by weight, at least 80% by weight, at least 85% by weight, at least 90% by weight, at least 95% by weight, or 100% by weight of a copolymer having a first structural repeating unit of ethylene and a second structural repeating unit selected from the following: (i) an acrylate-based moiety; (ii) at least 12% by weight relative to the total weight of the copolymer of vinyl acetate; and (iii) an anhydride or carboxylic acid. A “copolymer” is used herein to refer to macromolecules composed of at least two structurally distinct repeating units. “Copolymers” as used herein may include more than two structurally distinct repeating units. These copolymers may be obtained by copolymerization of two different monomers which are sometimes referred to as bipolymers, or those obtained from three different monomers which are referred to as terpolymers, or those obtained from four different monomers which are referred to as quaterpolymers, etc., chemical grafting of a first structural repeating unit onto the backbone of a polymer having a second structural repeating unit, or by combinations thereof.

Surprisingly, it has been discovered that the bulk layer and the capping layer of the present invention can be readily co-extruded together and have sufficient bond strength to each other despite their chemical dissimilarity. The bulk and capping layers of the present invention are capable of being extruded at a practical and controllable rate through a die and are capable of being thermoformed in a mould to give a thermoformed article of acceptable properties.

Another important aspect of the present invention is that the capping layer may be formulated to control the seal strength between it and the bulk layer. In some preferred embodiments, the seal strength between the capping layer and the bulk layer may vary between 450 gram/inch and 8000 gram/inch. This is also advantageous because the seal strength between these layers may be regulated to permit manual peelable opening of the package, yet be sufficiently high enough to prevent failure of the seal during normal handling and storage. A “manually peelable seal” and like terminology is used herein to refer to heat seals which are engineered to be readily peelable without uncontrolled or random tearing or rupturing the packaging materials which may result in premature destruction of the package and/or inadvertent contamination or spillage of the contents of the package. A manually peelable seal is one that can be manually peeled and/or fractured apart to open the package at the seal without resort to a knife or other implement to open the package.

In other preferred embodiments, the capping layer is on the inside of the tray where it comes into contact with the contents of the tray. In such embodiments, the capping layer acts as a heat seal layer and is formulated to heat seal to conventional polyolefin-based lidstock. In some preferred embodiments, the seal strength between the capping layer of the tray and lidstock may be controlled to provide a relatively strong heat seal between the tray and lidstock. This is advantageous because it permits the use of conventional lidding films which have a broad temperature range for heat sealing and generally readily seal through food contamination in the seal area. This is further advantageous because it allows for the use of conventional peelable lidding films having an internal frangible layer or interface and thus, a means to manually peel open a package. Manually peelable lidding films are known in the art and have been described in U.S. RE37,171 (Busche et al.), U.S. Pat. No. 7,927,679 (Cruz et al.), U.S. Pat. No. 8,283,010 (Cruz et al.), U.S. Pat. No. 8,283,011 (Cruz et al.), and U.S. Pat. No. 8,329,276 (Cruz).

In other preferred embodiments, the capping layer may be formulated such that the seal strength between the capping layer of the tray and lidstock is relatively weak to provide a manually peelable heat seal between the tray and lidstock.

In other preferred embodiments, the capping layer may be part of a multilayer film where a different layer acts as a heat seal layer and is in contact with the contents of the tray. In such embodiments, the bulk layer and the multilayer film may be readily co-extruded together.

The trays of the present invention may advantageously be used to hold oxygen or moisture sensitive food products and non-food articles. To this end, the capping layer may be part of a multilayer film which includes at least one oxygen and/or moisture barrier layer. The terms “barrier” or “barrier layer” as used herein means a layer which acts as a physical barrier to moisture and/or oxygen molecules. Oxygen barrier materials which may include, but are not limited to, ethylene vinyl alcohol copolymers (EVOH), polyacrylonitriles, polyamides (nylons), vinylidene chloride copolymers (PVDC) crystalline polyethylene terephthalate polymer (CPET). For some applications, the oxygen barrier material may also include metal foils, such as aluminum foil and barrier coatings deposited onto a polymer layer such as silica, alumina and the like. The tray having an oxygen barrier layer may exhibit an oxygen transmission rate of less than about 1.0 cm³/100 in²/24 h at 73° F., 0% RH and 1 atm (or about 15.5 cm³/m²/24 h at 23° C., 0% RH and 1 atm), preferably, less than about 0.5 cm³/100 in²/24 h at 73° F. 0% RH and 1 atm (or about 7.75 cm³/m²/24 h at 23° C., 0% RH and 1 atm), and most preferably, about 0.2 cm³/100 in²/24 h at 73° F., 0% RH and 1 atm (or about 3.1 cm³/m²/24 h at 23° C., 0% RH and 1 atm).

As used throughout this application, the terms “thermoformable” and “thermoformed” refer to monolayer or multilayer thermoplastic polymer sheets, films or webs having sufficient rigidity or stiffness to be formed into a desired shape by the application of a differential pressure between the film or sheet and a mold, by the application of heat, by the combination of heat and the application of a differential pressure between the film or sheet and a mold, or by any thermoforming technique known to those skilled in the art. In one conventional process, the thermoplastic polymers used to form the bulk and capping layers of the present invention may be co-extruded in sheet form and cooled. The sheets may then be subsequently reheated, for example by a hot roll, by a convection oven or by infrared heaters, placed over a mould and formed to the shape of the mould by the application of vacuum to the mould or by the application of pressure to the sheet. In an alternative method, the thermoplastic polymers used to form the bulk and capping layers may be co-extruded together and then thermoformed by a process commonly known as a “melt-to-mold” process. The “melt-to-mold” process is a method of manufacturing crystallizable polyester-containing articles which controls the cooling rate of the molten material and hence, the amount of crystallization present in the polyester. A number of prior patents describe the “melt-to-mold” method with which one of ordinary skill in the art may use to co-extrude and form the trays of the present invention; these include U.S. Pat. No. 4,061,706 (Duffield et al.), U.S. Pat. No. 5,106,567 (Demerest) and U.S. Pat. No. 6,077,904 (Dalgewicz III et al.), the disclosures of which are incorporated herein by references in their entireties.

As used throughout this application, the term “aromatic polyester” refers to any polyester having at least one phenyl (or benzene) moiety within one or both monomer repeating units used to form the material. Specific non-limiting examples of aromatic polyesters may include a homopolymer or copolymer of alkyl-aromatic esters including polyethylene terephthalate, polytrimethylene terephthalate, polybutylene terephthalate, polyhexamethylene terephthalate; polyethylene-2,6-naphthalate, polytrimethylene-2,6-naphthalate, polybutylene-2,6-naphthalate, polyhexamethylene-2,6-naphthalate, polyethylene isophthalate, polytrimethylene isophthalate, polybutylene isophthalate, polyhexamethylene isophthalate, poly-1,4-cyclohexane-dimethanoi terephthalate, and polybutylene adipate terephthalate and derivatives thereof.

It is within the scope of the present invention that crystallization may be induced in some amorphous aromatic polyesters by thermal crystallization, strain induced crystallization, nucleating agent crystallization or any combination thereof. Thermally induced crystallization occurs when the polymer is heated above its glass transition temperature, T. and not quenched rapidly enough. In stress-induced crystallization, stretching or orientation is applied to the heated polymer and the polymer chains are rearranged in a parallel fashion and become closely packed. As used throughout this application, the term “crystalline aromatic polyester” refers to any polyester having at least 1% by weight, at least 2% by weight, at least 5% by weight, at least 10% by weight, at least 15% by weight, at least 20% by weight, at least 30% by weight, at least 40% by weight, or at least 50% by weight crystallinity. One commonly known method of determining the degree of crystallinity of aromatic polyester is by the use of x-ray diffraction analysis.

### BRIEF DESCRIPTION OF THE DRAWINGS

Further features and advantages of the present invention will become apparent from the following detailed description, taken in combination with the appended drawings, in which:

FIG. 1 illustrates a schematic of one embodiment of a tray according to the present invention.

FIG. 2 illustrates a schematic cross-sectional view of one embodiment of a tray according to the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

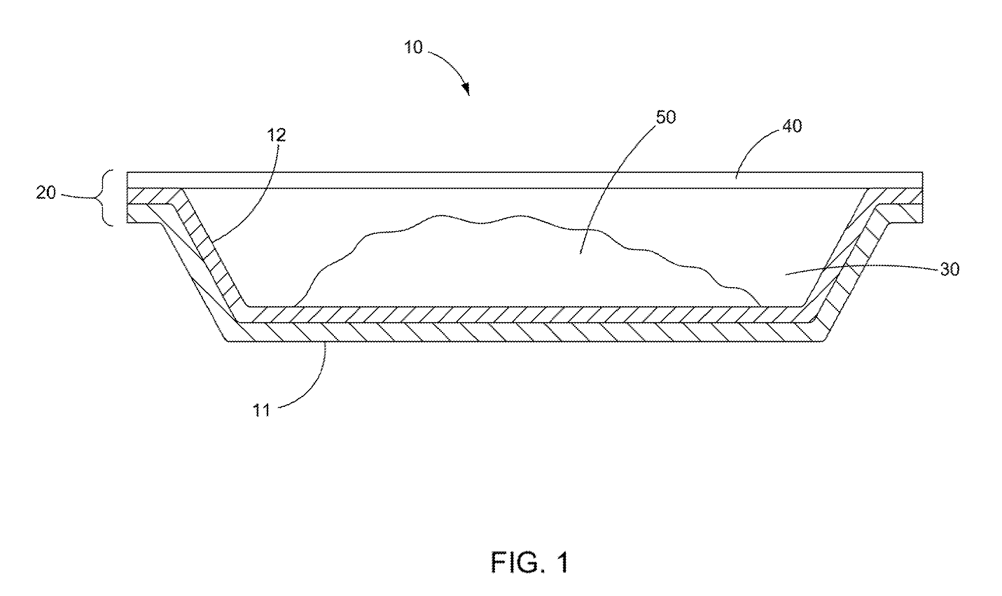

One preferred embodiment of tray 10 of the present invention is illustrated in FIG. 1. It should be understood that tray 10 may be of any shape desired, such as, for example, rectangular, square, and circular or polygon depending on both functional and aesthetic requirements. It will be appreciated that tray 10 is thermoformed to any depth as desired depending upon type and amount of food or non-food product to be packaged. It should also be appreciated that tray 10 may be configured to include two or more recessed areas (not shown) depending again on both functional and aesthetic requirements of a particular packaging application. In some preferred embodiments, tray 10 includes a sealing flange 20 extending around the periphery of a recessed cavity 30 to facilitate the sealing of a lidding film 40 to enclose a food product 50 as is shown in FIG. 1.

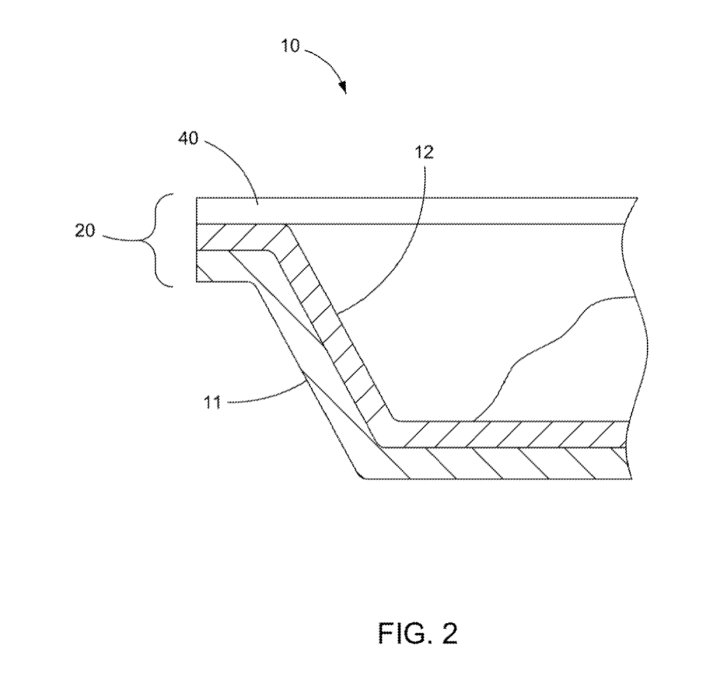

Referring now more particularly to FIG. 2 of the drawings, a preferred embodiment of tray 10 embodying the present invention is shown. Tray 10 includes a bulk layer 11 comprising a crystalline aromatic polyester and a capping layer 12 which is in direct contact with bulk layer 11. In some preferred embodiments, capping layer 12 is a monolayer film. In other preferred embodiments, capping layer 12 is a multilayer film.

In some preferred embodiments, bulk layer 11 comprises an aromatic polyester having between 20% and 40% crystallinity. Such crystalline aromatic polyester may include, but are not limited to, polyethylene terephthalate, polytrimethylene terephthalate, polybutylene terephthalate, polyhexamethylene terephthalate; polyethylene-2,6-naphthalate, polytrimethylene-2,6-naphthalate, polybutylene-2,6-naphthalate, polyhexamethylene-2,6-naphthalate, polyethylene isophthalate, polytrimethylene isophthalate, polybutylene isophthalate, polyhexamethylene isophthalate, poly-1,4-cyclohexane-dimethanol terephthalate, and polybutylene adipate terephthalate and derivatives thereof. In one preferred embodiment, bulk layer 11 comprises crystalline polyethylene terephthalate. It is also contemplated that additives such as, but not limited to, anti-oxidants, anti-static and anti-block agents, impact modifiers, nucleating agents, recycled PET, inorganic fillers, and other polymeric materials may be included in the bulk layer at concentrations typically known in the art to improve the extrusion process and layer properties of the final sheet. In the various embodiments of the invention, it is preferred that the bulk layer 11 makes up between 50% and 99% of the thickness of the tray. In other preferred embodiments, the bulk layer 11 has a thickness of between about 15 mil (381 micron) and about 50 mil (1270 micron). In particularly preferred compositions, bulk layer 11 includes between about 85% and 100% by weight of a crystalline polyethylene terephthalate and between 0% and 15% by weight of an additive mixture of impact modifiers, nucleating agents for recycled PET. In other particularly preferred compositions, bulk layer 11 may include mixtures described in U.S. Pat. No. 6,077,904, the disclosure of which is incorporated herein by reference in its entirety. For example, bulk layer 11 may include between about 60% and 99% by weight of a crystalline polyethylene terephthalate which functions as the base polymer, between about 1% and 15% by weight of additive mixture including an impact modifier from the group consisting of polymers of ethylene-methyl acrylate, ethylene-butyl acrylate, ethylene-ethyl acrylate, ethylene-vinyl acetate, ethylene-maleic acid, polypropylene, polybutadiene, polymethyl methacrylate-polycarbonate shell core modifier and paramethylstyrene, a compatibilizer which functions to improve the surface properties between the polyethylene terephthalate and the impact modifier and a nucleating agent, and between about 0% and 40% by weight of recycled PET.

The capping layer 12 includes a copolymer having at least a first structurally distinct repeating unit of ethylene and a second structurally distinct repeating unit selected from the following: (i) an acrylate-based moiety; (ii) at least 12% by weight relative to the total weight of the copolymer of vinyl acetate; and (iii) an anhydride or carboxylic acid. In some preferred embodiments, the capping layer 12 is a monolayer film. In other preferred embodiments, capping layer 12 is a multilayer film coextruded with bulk layer 11 where the layer in direct contact with bulk layer 11 comprises a copolymer having at least a first structurally distinct repeating unit of ethylene and a second structurally distinct repeating unit selected from the following: (i) an acrylate-based moiety; (ii) at least 12% by weight relative to the total weight of the copolymer of vinyl acetate; and (iii) an anhydride or carboxylic acid.

In some preferred embodiments, the capping layer 12 comprises an ethylene copolymer which includes a second structural repeating unit of an acrylate-based moiety. The acrylate-based moiety may include, but is not limited to any selected from the group consisting of butyl acrylate, ethyl acrylate, ethyl methacrylate, methyl acrylate, methyl methacrylate, 2-ethylhexyl acrylate, glycidyl methacrylate, and blends thereof. In other preferred embodiments, the acrylate-based moiety is methyl acrylate. Such embodiments may include at least 21% by weight relative to the total weight of the copolymer of the methyl acrylate structural repeating unit.

In other preferred embodiments, the capping layer 12 comprises an ethylene copolymer which includes a second structural repeating unit of a carboxylic acid moiety. The carboxylic acid may include, but is not limited to any selected from the group consisting of acrylic acid, methacrylic acid, α-ethylacrylic acid, maleic acid, fumaric acid, itaconic acid, citraconic acid, tetrahydrophthalic acid, methyltetrahydrophthalic acid, and endo-cis-bicyclo[2,2,1]-hepto-5-ene-2,3-dicarboxylic acid.

In other preferred embodiments, the capping layer 12 comprises an ethylene copolymer which includes a second structural repeating unit of an anhydride moiety. The anhydride may include, but is not limited to any cyclic and/or linear anhydride known in the art. Useful examples of cyclic anhydrides include itaconic anhydride and maleic anhydride and alkyl substituted derivatives thereof. Other non-limiting examples of cyclic anhydrides are those derived from monomers selected from the group consisting of allyl succinic anhydride, isobutenyl succinic anhydride, butenyl succinic anhydride, octenyl succinic anhydride, nonenyl succinic anhydride, dodecenyl succinic anhydride, tetradecenyl succinic anhydride, n-hexadecenyl succinic anhydride, iso-hexadecenyl succinic anhydride, n-octadecenyl succinic anhydride, iso-octadecenyl succinic anhydride, and n-triacontenyl succinic anhydride. In some preferred embodiments, the anhydride structural repeating unit is maleic anhydride.

Capping layer 12 may also comprise a copolymer having at least a first structurally distinct repeating unit of ethylene, a second structurally distinct repeating unit and a third structurally distinct repeating units. The second and third structural repeating units may include any acrylate-based moiety, vinyl acetate, anhydride or carboxylic acid as described above. For example, in some preferred embodiments, the capping layer 12 comprises a terpolymer having a first structural repeating unit of ethylene, a second structural repeating unit and a third structural repeating unit which is different than the second structural repeating unit. In some preferred embodiments, the second structural repeating unit includes methyl acrylate and the third structural repeating unit includes maleic anhydride. In a particularly preferred embodiment, the methyl acrylate is about 24% by weight relative to the total weight of the copolymer and the maleic anhydride is about 0.1% by weight relative to the total weight of the copolymer. In other preferred embodiments, the capping layer 12 includes a terpolymer where the first structural repeating unit is ethylene, the second structural repeating unit is vinyl acetate and the third structural repeating unit is maleic anhydride. In a particularly preferred embodiment, the vinyl acetate is at least about 9.5% by weight relative to the total weight of the copolymer and the maleic anhydride is at least about 0.1% by weight relative to the total weight of the copolymer. In still further preferred embodiments, the capping layer 12 comprises a terpolymer having a first structural repeating unit of ethylene, the second structural repeating unit of methyl acrylate and the third structural repeating unit of glycidyl methacrylate. In a particularly preferred embodiment, the methyl acrylate is about 24% by weight relative to the total weight of the copolymer and the glycidyl methacrylate is about 8% by weight relative to the total weight of the copolymer.

### WORKING EXAMPLES

In the following Examples 1-13 and Comparative Examples 1-3, there is described various embodiments of a tray 10 having a two-layer structure as illustrated in FIGS. 1-2. In all these examples, the bulk layer 11 and capping layer 12 were co-extruded into a sheet form using single-screw laboratory extruders (LabTech Engineering Company, Ltd. Thailand) In all these examples, the thickness of the bulk layer was about 8 mil (203 micron) and the thickness of the capping layer was about 3 mil (76 micron).

### Example 1

Example 1 is one preferred embodiment of tray 10 of the present invention having a structure and layer compositions as described below. Reported below is the layer composition relative to the total weight of the layer.
Layer 11: 86 wt.-% of a crystalline polyethylene terephthalate (CPET)-LASER+C9921 (DAK Americas LLC, Charlotte, N.C., USA) and 14 wt.-% of an additive mixture.
Layer 12: 100 wt.-% of an ethylene methyl acrylate copolymer having a methyl acrylate content of 21.5 wt.-%, a density of 0.943 g/cm³ and a melt index of 0.4 g/10 min-EMAC® SP2202 (Westlake Chemical Company, Houston, Tex., USA).

### Example 2

Example 2 is another preferred embodiment of tray 10 of the present invention having a structure and layer compositions as described below. Reported below is the layer composition relative to the total weight of the layer.
Layer 11: 86 wt.-% of a crystalline polyethylene terephthalate (CPET)-LASER+C9921 (DAK Americas LLC, Charlotte, N.C., USA) and 14 wt.-% of an additive mixture.
Layer 12: 100 wt.-% of an ethylene methyl acrylate copolymer having a methyl acrylate content of 20 wt.-%, a density of 0.942 g/cm³ and a melt index of 8 g/10 min-DuPont™ Elvaloy® AC 1820 (E.I. du Pont de Nemours and Company, Wilmington, Del., USA).

### Example 3

Example 3 is another preferred embodiment of tray 10 of the present invention having a structure and layer compositions as described below. Reported below is the layer composition relative to the total weight of the layer.
Layer 11: 86 wt.-% of a crystalline polyethylene terephthalate (CPET)-LASER+C9921 (DAK Americas LLC, Charlotte, N.C., USA) and 14 wt.-% of an additive mixture.
Layer 12: 100 wt.-% of an ethylene vinyl acetate copolymer having a vinyl acetate content of 28 wt.-%, a density of 0.95 g/cm³ and a melt index of 6 g/10 min-DuPont™ Elvax® 3175 (E.I. du Pont de Nemours and Company, Wilmington, Del., USA).

### Example 4

Example 4 is another preferred embodiment of tray 10 of the present invention having a structure and layer compositions as described below. Reported below is the layer composition relative to the total weight of the layer.
Layer 11: 86 wt.-% of a crystalline polyethylene terephthalate (CPET)-LASER+C9921 (DAK Americas LLC, Charlotte, N.C., USA) and 14 wt.-% of an additive mixture,
Layer 12: 100 wt.-% of an ethylene vinyl acetate copolymer having a vinyl acetate content of 18 wt.-%, a density of 0.94 g/cm³ and a melt index of 30 g/10 min-DuPont™ Elvax® 3176 (E.I. du Pont de Nemours and Company, Wilmington, Del., USA).

### Example 5

Example 5 is another preferred embodiment of tray 10 of the present invention having a structure and layer compositions as described below. Reported below is the layer composition relative to the total weight of the layer.
Layer 11: 86 wt.-% of a crystalline polyethylene terephthalate (CPET)-LASER+C9921 (DAK Americas LLC, Charlotte, N.C., USA) and 14 wt.-% of an additive mixture.
Layer 12: 100 wt.-% of an ethylene vinyl acetate copolymer having a vinyl acetate content of 12 wt.-%, a density of 0.93 g/cm³ and a melt index of 0.35 g/10 min-DuPont™ Elvax® 3135XZ (E.I. du Pont de Nemours and Company, Wilmington, Del., USA).

### Example 6

Example 6 is another preferred embodiment of tray 10 of the present invention having a structure and layer compositions as described below. Reported below is the layer composition relative to the total weight of the layer.
Layer 11: 86 wt.-% of a crystalline polyethylene terephthalate (CPET)-LASER+C9921 (DAK Americas LLC, Charlotte, N.C., USA) and 14 wt.-% of an additive mixture.
Layer 12: 100 wt.-% of an ethylene-based anhydride grafted copolymer elastomer having a density of 0.89 g/cm³ and a melt index of 7.2 g/10 min-ADMER™ SE810 (Mitsui Chemicals America, Inc. of Rye Brook, N.Y., USA).

### Example 7

Example 7 is another preferred embodiment of tray 10 of the present invention having a structure and layer compositions as described below. Reported below is the layer composition relative to the total weight of the layer.
Layer 11: 86 wt.-% of a crystalline polyethylene terephthalate (CPET).-LASER+C9921 (DAK Americas LLC, Charlotte, N.C., USA) and 14 wt-% of an additive mixture.
Layer 12: 100 wt.-% of an ethylene-based anhydride grafted copolymer elastomer having a density of 0.89 g/cm³ and a melt index of 2.6 g/10 min-ADMER™ SF755A (Mitsui Chemicals America, Inc. of Rye Brook, N.Y., USA).

### Example 8

Example 8 is another preferred embodiment of tray 10 of the present invention having a structure and layer compositions as described below. Reported below is the layer composition relative to the total weight of the layer
Layer 11: 86 wt.-% of a crystalline polyethylene terephthalate (CPET)-LASER+C9921 (DAK Americas LLC, Charlotte, N.C., USA) and 14 wt.-% of an additive mixture.
Layer 12: 100 wt.-% of an anhydride modified linear low density polyethylene copolymer having a density of 0.918 g/cm³ and a melt index of 8.0 g/10 min-Westlake TYMAX™ GT4300 (Westlake Chemical Corporation, Houston, Tex., USA).

### Example 9

Example 9 is another preferred embodiment of tray 10 of the present invention having a structure and layer compositions as described below. Reported below is the layer composition relative to the total weight of the layer.
Layer 11: 86 wt.-% of a crystalline polyethylene terephthalate (CPET)-LASER+C9921 (DAK Americas LLC, Charlotte, N.C., USA) and 14 wt.-% of an additive mixture.
Layer 12: 100 wt.-% of an anhydride modified linear low density polyethylene copolymer having a density of 0.91 g/cm³ and a melt index of 2.7 g/10 min-DuPont™ Bynel® 41E710 (E.I. du Pont de Nemours and Company, Wilmington, Del., USA).

### Example 10

Example 10 is another preferred embodiment of tray 10 of the present invention having a structure and layer compositions as described below. Reported below is the layer composition relative to the total weight of the layer.
Layer 11: 86 wt.-% of a crystalline polyethylene terephthalate (CPET)-LASER+C9921 (DAK Americas LLC, Charlotte, N.C., USA) and 14 wt.-% of an additive mixture.
Layer 12: 100 wt.-% of an anhydride modified acrylate terpolymer having a methyl acrylate content of 24 wt.-%, a density of 0.943 g/cm³ and a melt index of 2.7 g/10 min-TYMAX™ GT7058 (Westlake Chemical Corporation, Houston, Tex., USA).

### Example 11

Example 11 is another preferred embodiment of tray 10 of the present invention having a structure and layer compositions as described below. Reported below is the layer composition relative to the total weight of the layer.
Layer 11: 86 wt.-% of a crystalline polyethylene terephthalate (CPET)-LASER+C9921 (DAK Americas LLC, Charlotte, N.C., USA) and 14 wt.-% of an additive mixture.
Layer 12: 100 wt.-% of an anhydride modified ethylene vinyl acetate terpolymer having density of 0.95 g/cm³ and a melt index of 6.7 g/10 min-DuPont™ Bynel™ 1123 (E.I. du Pont de Nemours and Company, Wilmington, Del., USA).

### Example 12

Example 12 is another preferred embodiment of tray 10 of the present invention having a structure and layer compositions as described below. Reported below is the layer composition relative to the total weight of the layer.
Layer 11: 86 wt.-% of a crystalline polyethylene terephthalate (CPET)-LASER+C9921 (DAK Americas LLC, Charlotte, N.C., USA) and 14 wt.-% of an additive mixture.
Layer 12: 100 wt.-% of an anhydride modified ethylene vinyl acetate terpolymer having density of 0.94 g/cm³ and a melt index of 0.85 g/10 min-DuPont™ Bynel® 3930 (E.I. du Pont de Nemours and Company, Wilmington, Del., USA).

### Example 13

Example 13 is another preferred embodiment of tray 10 of the present invention having a structure and layer compositions as described below. Reported below is the layer composition relative to the total weight of the layer.
Layer 11: 86 wt.-% of a crystalline polyethylene terephthalate (CPET)-LASER+C9921 (DAK Americas LLC, Charlotte, N.C., USA) and 14 wt.-% of an additive mixture,
Layer 12: 100 wt.-% of an ethylene glycidyl methacrylate terpolymer having a methyl acrylate content of 24 wt.-%, a glycidyl methacrylate content of 8 wt.-%, a density of 0.94 g/cm³ and a melt index of 6 g/10 min-LOTADER® AX8900 (Arkema, Colombes, France).

### Comparative Example 1

Comparative Example 1 is an embodiment of a tray having a structure and layer compositions as described below. Reported below is the layer composition relative to the total weight of the layer.
Layer 11: 86 wt.-% of a crystalline polyethylene terephthalate (CPET)-LASER+C9921 (DAK Americas LLC, Charlotte, N.C., USA) and 14 wt.-% of an additive mixture.
Layer 12: 100 wt.-% of an ethylene vinyl acetate copolymer (EVA) having a 10% vinyl acetate content, a melt index of 0.3 g/10 min-DuPont™ Elvax® 3129-1 (E.I. du Pont de Nemours and Company, Wilmington, Del., USA).

### Comparative Example 2

Comparative Example 2 is an embodiment of a tray having a structure and layer compositions as described below. Reported below is the layer composition relative to the total weight of the layer.
Layer 11: 86 wt.-% of a crystalline polyethylene terephthalate (CPET)-LASER+C9921 (DAK Americas LLC, Charlotte, N.C., USA) and 14 wt.-% of an additive mixture.
Layer 12: 100 wt.-% of an ethylene vinyl acetate copolymer (EVA) having a 4% vinyl acetate content, a melt index of 1.0 g/10 min-Petrothene® NA340 (LyondellBasell Industries, Houston, Tex., USA).

### Comparative Example 3

Comparative Example 3 is an embodiment of a tray having a structure and layer compositions as described below. Reported below is the layer composition relative to the total weight of the layer.
Layer 11: 86 wt.-% of a crystalline polyethylene terephthalate (CPET)-LASER+C9921 (DAK Americas LLC, Charlotte, N.C., USA) and 14 wt-% of an additive mixture.
Layer 12: 90 wt.-% of an ethylene vinyl acetate copolymer (EVA) having a 10% vinyl acetate content, a melt index of 0.3 g/10 min-DuPont™ Elvax® 3129-1 (E.I. du Pont de Nemours and Company, Wilmington, Del., USA)+10 wt.-% of a polypropylene (PP)-Total 3576 (Total Petrochemicals USA, La Porte, Tex., USA).

### Bond Strength Between Bulk and Capping Layers

Specimens for testing bond strength between the bulk layer and the capping layer of each of the above examples were prepared by first heat sealing each example to a two-layer support substrate of 75-gauge OPET/3-mil EVA with capping layer (layer 12) of each example being heat sealed to the EVA layer of the support substrate. The heat sealing parameters were 300° F. (149° C.) under a pressure of 40 psi for a dwell time of 1 second. Next, the specimens were cut to roughly 1-inch wide by 4-inch long pieces and an end section of the bulk layer and capping layer with the two-layer support substrate were secured to an Instron® Pull Tester Model No. 5967 (Norwood, Mass. USA). Each specimen was pulled apart at a 180° angle at a rate of 12 in/min while the average force (gram/inch) to separate the bulk layer from the capping layer of the specimen was measured at room temperature (23° C.) in accordance with ASTM Test Method F-904. The results are reported in TABLE 1 below.

TABLE 1
Bond Strength Between Bulk and Capping Layers

| | Average Bond |
|---|---|
| Sample | Strength (g/in) |
| Example 1 | 1757 |
| Example 2 | 6062 |
| Example 3 | 3100 |
| Example 4 | 2998 |
| Example 5 | 1199 |
| Example 6 | >8000^{†} |
| Example 7 | 3435 |
| Example 8 | 1873 |
| Example 9 | 450 |
| Example 10 | 3100 |
| Example 11 | 3203 |
| Example 12 | 2028 |
| Example 13 | 6646 |
| Comparative | 60 |
| Example 1 | |
| Comparative | 7 |
| Example 2 | |
| Comparative | 15 |
| Example 3 | |

^{†}Indicates destructive failure of the film.

It should be evident to one of ordinary skill in the art that based on the above results the bond strength between a bulk layer of crystalline PET and a capping layer comprising a copolymer having a first structural repeating unit of ethylene and a second structural repeating unit selected from the following: (i) an acrylate-based moiety; (ii) at least 12% by weight relative to the total weight of the copolymer of vinyl acetate; and (iii) an anhydride or carboxylic acid may be controlled to provide a bond strength value within a range of between 450 g/in and 8000 g/in. and thus, readily adjusted to meet the needs of a particular application by selective formulation of the capping layer composition.

The above description and examples illustrate certain embodiments of the present invention and are not to be interpreted as limiting. Selection of particular embodiments, combinations thereof, modifications, and adaptations of the various embodiments, conditions and parameters normally encountered in the art will be apparent to those skilled in the art and are deemed to be within the spirit and scope of the present invention.

What is claimed is:

1. A tray comprising:
a bulk layer comprising a crystalline aromatic polyester; and
a capping layer in direct contact with the bulk layer; wherein the capping layer comprises a copolymer comprising at least a first structural repeating unit of ethylene and a second structural repeating unit selected from the following:
i) an acrylate-based moiety;
ii) at least 12% by weight relative to the total weight of the copolymer of vinyl acetate; and
iii) an anhydride or carboxylic acid.

2. The tray according to claim 1, wherein the crystalline aromatic polyester is selected from the group consisting of polyethylene terephthalate, polytrimethylene terephthalate, polybutylene terephthalate, polyhexamethylene terephthalate; polyethylene-2,6-naphthalate, polytrimethylene-2,6-naphthalate, polybutylene-2,6-naphthalate, polyhexamethylene-2,6-naphthalate, polyethylene isophthalate, polytrimethylene isophthalate, polybutylene isophthalate, polyhexamethylene isophthalate, poly-1,4-cyclohexane-dimethanol terephthalate, and polybutylene adipate terephthalate and derivatives thereof.

3. The tray according to claim 1, wherein the crystalline aromatic polyester is polyethylene terephthalate.

4. The tray according to claim 1, wherein the acrylate-based moiety is selected from the group consisting of butyl acrylate, ethyl acrylate, ethyl methacrylate, methyl acrylate, methyl methacrylate, 2-ethylhexyl acrylate, glycidyl methacrylate, and blends thereof.

5. The tray according to claim 4, wherein the acrylate-based moiety is methyl acrylate.

6. The tray according to claim 5, wherein the methyl acrylate is at least 21% by weight relative to the total weight of the copolymer.

7. The tray according to claim 1, wherein the carboxylic acid is selected from the group consisting of acrylic acid, methacrylic acid, α-ethylacrylic acid, maleic acid, fumaric acid, itaconic acid, citraconic acid, tetrahydrophthalic acid, methyltetrahydrophthalic acid, and endo-cis-bicyclo[2,2,1]-hepto-5-ene-2,3-dicarboxylic acid.

8. The tray according to claim 1, wherein the anhydride is maleic anhydride or a derivative thereof.

9. The tray according to claim 1, wherein the capping layer is a monolayer.

10. The tray according to claim 1, wherein the capping layer is a multilayer film.

11. The tray according to claim 1, wherein the capping layer comprises a copolymer comprising a third structural repeating unit.

12. The tray according to claim 11, wherein the third structural repeating unit is a different structural repeating unit than the second structural repeating unit.

13. The tray according to claim 12, wherein the second structural repeating unit is methyl acrylate and the third structural repeating unit is maleic anhydride.

14. The tray according to claim 13, wherein the methyl acrylate is about 24% by weight relative to the total weight of the copolymer and the maleic anhydride is about 0.1% by weight relative to the total weight of the copolymer.

15. The tray according to claim 11, wherein the second structural repeating unit is vinyl acetate and the third structural repeating unit is maleic anhydride.

16. The tray according to claim 15, wherein the vinyl acetate is at least about 9.5% by weight relative to the total weight of the copolymer and the maleic anhydride is at least about 0.1% by weight relative to the total weight of the copolymer.

17. The tray according to claim 11, wherein the second structural repeating unit is methyl acrylate and the third structural repeating unit is glycidyl methacrylate.

18. The tray according to claim 17, wherein the methyl acrylate is about 24% by weight relative to the total weight of the copolymer and the glycidyl methacrylate is about 8% by weight relative to the total weight of the copolymer.

19. The tray according to claim 1, wherein the bulk layer and the capping layer has a bond strength of at least about 450 grams/inch.

20. The tray according to claim 1, wherein the bulk layer and the capping layer has a bond strength of at least about 1,000 grams/inch.

21. The tray according to claim 1, wherein the bulk layer comprises a crystalline aromatic polyester having between 20% and 40% crystallinity.
